(19) United States
(12) Patent Application Publication
(10) Pub. No.: US 2019/0308836 A1
(43) Pub. Date: Oct. 10, 2019

(54) REGISTRATION SYSTEM OF A PRINTING DEVICE WITH MULTI-ROTATIONAL WHEELS

(71) Applicant: Xerox Corporation, Norwalk, CT (US)

(72) Inventors: Jacob R. McCarthy, Williamson, NY (US); Timothy D. Slattery, Elma, NY (US); Joseph M. Ferrara, JR., Webster, NY (US); James L. Pratt, Penfield, NY (US); Dara N. Lubin, Pittsford, NY (US); Ron Edward Dufort, Rochester, NY (US); Elizabeth M. Crossen, Churchville, NY (US); Daniel M. McHugh, Rochester, NY (US); Rachel Lynn Bierasinski, Rochester, NY (US); Frank Berkelys Tamarez Gomez, Webster, NY (US); Paul M. Fromm, Rochester, NY (US); Erwin Ruiz, Rochester, NY (US)

(21) Appl. No.: 15/948,455

(22) Filed: Apr. 9, 2018

(51) Int. Cl. B65H 9/10; B41J 13/32; B41J 13/00; B41J 29/393

(52) U.S. Cl. CPC B65H 9/106; B41J 29/393; B41J 13/0027; B41J 13/32

(57) ABSTRACT

A registration system for a printing device and a method for controlling the same are disclosed. For example, the registration system includes at least one sensor to detect a position of a print media, a platform comprising at least one multi-rotational wheel, and a processor communicatively coupled to the at least one sensor and the at least one multi-rotational wheel, wherein the processor calculates a desired movement of the at least one multi-rotational wheel based on the position of the print media.

The present disclosure relates generally to printing devices and, more particularly, to a registration system of a printing device with multi-rotational wheels.

### BACKGROUND

Printing devices can be used to print images on print media. The print media can be fed through the printing device along a transport path and imaging path to have the image printed. Along the transport path and the imaging path, there are certain locations where processing errors can occur that can cause a misalignment of the image relative to the print media.

For example, the print devices can have a registration system. The registration system may be responsible for correctly feeding the print media to an imaging system such that the printed image is correctly aligned with the print media. As the size and weight of print media grows larger and larger, it can be more and more difficult for currently designed registration systems to handle the larger print media.

### SUMMARY

According to aspects illustrated herein, there are provided a registration system for a printing device and a method for controlling the same. One disclosed feature of the embodiments is a registration system for a printing device comprising at least one sensor to detect a position of a print media, a platform comprising at least one multi-rotational wheel, and a processor communicatively coupled to the at least one sensor and the at least one multi-rotational wheel, wherein the processor calculates a desired movement of the at least one multi-rotational wheel based on the position of the print media.

Another disclosed feature of the embodiments is a method for controlling a position of a print media in a registration system. In one embodiment, the method detects a position of a print media via at least one sensor, determines a desired movement of at least one multi-rotational wheel based on the position of the print media, and moves the at least one multi-rotational wheel in accordance with the desired movement to adjust the position of the print media.

### BRIEF DESCRIPTION OF THE DRAWINGS

The teaching of the present disclosure can be readily understood by considering the following detailed description in conjunction with the accompanying drawings, in which:

FIG. 1 illustrates a block diagram of an example printing device of the present disclosure;

FIG. 2 illustrates a top view block diagram of an first example registration system of the present disclosure;

FIG. 3 illustrates a top view block diagram of a second example registration system of the present disclosure;

FIGS. 4A-4B illustrate a third example registration system of the present disclosure;

FIG. 5 illustrates a flowchart of an example method for controlling a position of a print media in a registration system; and

FIG. 6 illustrates a high-level block diagram of an example computer suitable for use in performing the functions described herein.

To facilitate understanding, identical reference numerals have been used, where possible, to designate identical elements that are common to the figures.

### DETAILED DESCRIPTION

The present disclosure is related to a registration system of a printing device with multi-rotational wheels and a method for registering a print media using the registration system of the present disclosure. As discussed above, printing devices can have a registration system. The registration system may be responsible for correctly feeding the print media to an imaging system such that the printed image is correctly aligned with the print media. As the size and weight of print media grows larger and larger, it can be more and more difficult for currently designed registration systems to handle the larger print media.

Registration systems may include center registered systems and edge registered systems. Current designs for some registration systems require the use of three nips and/or a movable registration carriage. The movable registration carriage may help adjust for lateral input error.

A center nip may be vertically movable (e.g., up and down). As a result, for smaller sheets of print media, the center nip may be moved down to engage the print media. For larger sheets of print media, the center nip may be moved up to disengage the print media and allow the outer two nips to engage the print media. However, if a sheet of print media that is sized between the smallest sheet and the largest sheet is received, the registration system may have difficulty handling the print media.

In addition, the nips in the registration system may be spaced to handle the smallest sized print media. However, this may cause one of the nips to be located more towards a center of along a width of the paper path or both nips may be located offset to one side of the paper path. When the nips are in fixed locations, and a sheet that is smaller than the largest expected size and larger than the smallest expected size of print media is received, the location of the nips may not be ideal for aligning the print media.

Furthermore, it may take additional time for the nips to open and close (e.g., move up and down) based on the width of the print media that is used. The delay to open and close the nips may add additional processing time for print jobs.

Embodiments of the present disclosure provide a registration system that uses multi-rotational wheels to correct various alignment errors, such as lateral input errors, skew, and the like. The multi-rotational wheels provide greater directional control of the print media within the registration system and improve the efficiency of the print jobs. For example, the multi-rotational wheels may provide skew correction and lateral position correction without overcorrecting and “tail-wagging” the print media. In addition, some of the nips and the movable registration carriage may be replaced in the registration system with the multi-rotational wheels.

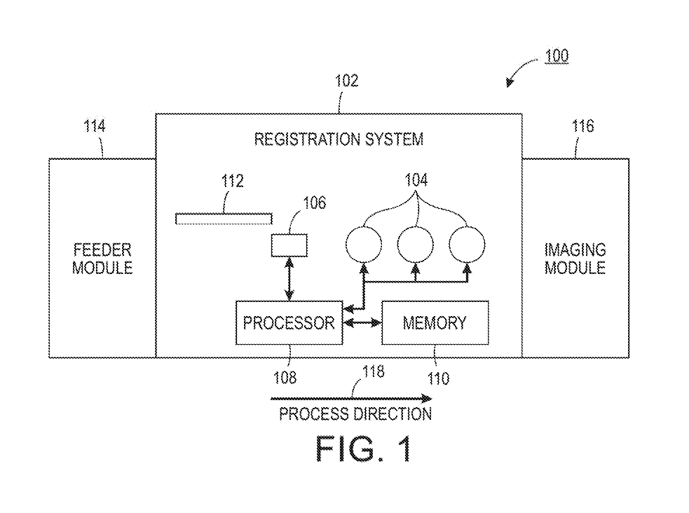

FIG. 1 illustrates a block diagram of an example printing device 100 of the present disclosure. The printing device 100 may be any type of printing device such as a multi-function device (MFD), a copy machine, laser printer, an ink jet printer, and the like.

In one embodiment, the printing device 100 may include a feeder module 114, a registration system 102, and an imaging module 116. It should be noted that the printing device 100 has been simplified for ease of explanation. The printing device 100 may include additional components and modules that are not shown. For example, the printing device 100 may include a finishing module, print heads, a duplex paper path, a digital front end, a graphical user interface (GUI), and the like.

In one embodiment, the feeder module 114 may include feeder trays that feed a print media 112 through the printing device 100. The print media 112 may be any type of print media such as paper, card stock, and the like, and have any dimensions. In one embodiment, the printing device 100 of the present disclosure may be designed to handle print media 112 with high aspect ratios or very long lengths (e.g., 40 inches or longer). The feeder module 114 may feed the print media 112 to a registration system 102.

In one embodiment, the registration system 102 may include at least one multi-rotational wheel 104 and at least one sensor 106. The registration system 102 may include additional transport nips, idler rollers, and platforms that are not shown.

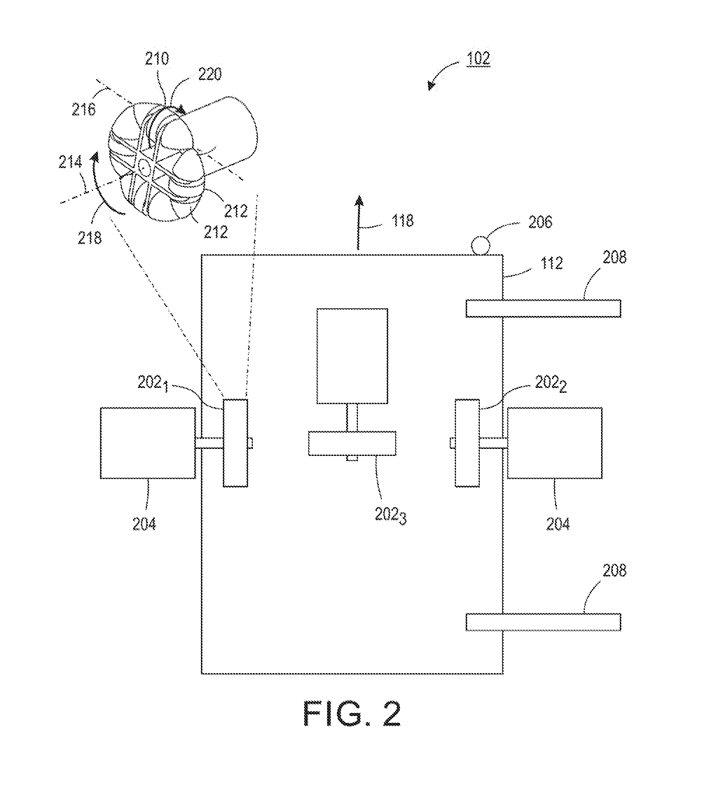

In one embodiment, the at least one multi-rotational wheel 104 may be a type of wheel that provides at least two different directions of rotation within a single wheel. For example, the wheel may provide rotation in a process direction and have components that may provide rotation in a cross-process direction. In one embodiment, one direction of rotation may be controlled by a motor and the other direction of rotation may be a free rotation. In one embodiment, both directions of rotation may be independently controlled by separate motors. As a result, the multiple directions of rotation within a single wheel may allow the multi-rotational wheel 104 to provide skew adjustments and lateral position adjustments for the print media 112. Different examples of the multi-rotational wheel 104 are illustrated in FIGS. 2-4 and discussed in further details below.

In one embodiment, the sensor 106 may be located upstream from the multi-rotational wheel 104. The sensor 106 may be any type of sensor that can detect a position of the print media 112. For example, the sensor 106 may be a charged coupled device (CCD) sensor, a contact image sensor (CIS), a capacitive sensor, a resistive sensor, an image based sensor, and the like.

The position detected by the sensor 106 may include a skew and a lateral position of the print media 112. The skew may measure an amount of tilt, or angle, in an inboard or an outboard direction relative to a line that is parallel to a process direction 118. In other words, zero skew may mean that both sides of the leading edge would reach the sensor 106 simultaneously. If there is skew, one side (e.g., the left side) of the leading edge may reach the sensor 106 before the other side (e.g., the right side) of the leading edge reaches the sensor 106.

The lateral position may detect an amount a distance from a desired alignment position. For example, if the printing device 100 is a center registered device, then the lateral position may measure a distance that a center of the print media 112 is away from a center of the registration system 102. In another example, if the printing device 100 is an edge registered device, then the lateral position may measure a distance that an edge of the print media 112 is from a registration edge of the registration system 102.

In one embodiment, the registration system 102 may include a processor 108 and a memory 110. The processor 108 may be communicatively coupled to the multi-rotational wheel or wheels 104, the sensor 106, and the memory 110. The position of the print media 112 detected by the sensor 106 may be transmitted to the processor 108. The processor 108 may then control the multi-rotational wheel or wheels 104 by a desired amount to adjust the position of the print media 112 into a correct position.

The registration system 102 may position the print media 112 properly such that the print media 112 is aligned with a desired image that is printed onto the print media 112. In other words, the registration system 102 may prevent printing errors where the desired image is angled, tilted, or off center on the print media 112 due to skew or lateral position errors.

In one embodiment, the memory 110 may store instructions that are executed by the processor 108 to perform the adjustment or to control the multi-rotational wheel or wheels 104 by the desired amount. The memory 110 may also store data used by the processor 108 to perform the calculations to determine the desired amount of movement of the multi-rotational wheel or wheels 104.

In one embodiment, the imaging module 116 may print a desired image onto the print media 112. The imaging module 116 may use any type of printing means to print the desired image. For example, the imaging module 116 may include an imaging belt that transfers toner that is dispensed onto the imaging belt onto the print media 112. In another example, the imaging module 116 may include ink jet print heads that print a desired image onto the print media 112, and the like.

FIGS. 2-4 illustrate different types of multi-rotational wheels 104 that can be deployed in the registration system 102. In one embodiment, the multi-rotational wheel 104 may be an omni wheel 202. Each omni wheel 202 may include a body portion 210 and a plurality of roller components 212 coupled around an outer perimeter of the body portion 210. The plurality of roller components 212 may be fabricated from a plastic or a rubber material. The plurality of roller components 212 may have an approximately cylindrical shape with a smooth surface. The dimensions of the omni wheel 202 and the plurality of roller components 212 and a number of the plurality of roller components 212 may be a function of a size of the print media 112 that the registration system 102 is designed to handle.

The body portion 210 may rotate around a central axis 214 as shown by an arrow 218. The plurality of roller components 212 may each rotate freely around a respective axis 216 as shown by an arrow 220. In other words, the central axis 214 may be perpendicular to the respective axis 216 of each one of the plurality of roller components 212. As a result, the omni wheel 202 may provide multiple directions of rotation.

In one embodiment, each one of the omni wheels 202 may be coupled to a respective motor 204. The motor 204 may be communicatively coupled to the processor 108. In one embodiment, the desired movement may be a rotational speed of the omni wheel 202 as controlled by operation of the motor 204.

The registration system 102 in FIG. 2 may also include a point sensor 206 and CCD or CIS sensors 208. When a leading edge of the print media 112 reaches the point sensor 206, the CCD or CIS sensors 208 may measure the skew and the lateral position of the print media 112. The skew and the lateral position of the print media 112 may be transmitted by the processor to calculate the desired movement.

In one embodiment, the omni wheels 202 may be arranged to control skew and lateral position of the print media 112. By control the rotational speed of each omni wheel 202 independently, the omni wheels 202 may adjust the skew and the lateral position of the print media 112 as the print media moves in the process direction 118.

In one embodiment, at least two omni wheels 202₁ and 202₂ may be spaced apart across a width of the print media 112. In other words, the two omni wheels 202₁ and 202₂ may be aligned in an inboard and outboard direction. The two omni wheels 202₁ and 202₂ may be positioned such that the body portion 210 rotates in the process direction and the plurality of roller components 212 rotate in the cross-process direction (e.g., in an inboard or outboard direction).

In one embodiment, at least one omni wheel 202₃ may be located between the two omni wheels 202₁ and 202₂. The omni wheel 202₃ may be located at a center of the two wheels 202₁ and 202₂. The omni wheel 202₃ may be positioned such that the body portion 210 rotates in a cross-process direction and the plurality of roller components 212 rotate in the process direction 118.

Thus, the arrangement of the omni wheels 202₁, 202₂, and 202₃ allows the registration system 102 to adjust a skew and a lateral position of the print media 112 without a movable registration carriage, opening and closing different nips, and the like. For example, the omni wheel 202₃ may rotate to adjust the lateral position of the print media 112. The omni wheels 202₁ and 202₂ may be rotated at different speeds to adjust a skew, in either direction, of the print media 112. Thus, based on the amount of skew and the lateral position of the print media 112 that is detected, the processor 108 may control operation of the respective motors 204 to rotate the omni wheels 202₁, 202₂, and 202₃ by a desired rotational speed to correct the skew and the lateral position.

In one embodiment, a fourth omni wheel 202 may be positioned across from and aligned with the omni wheel 202₃. In other words, the registration system 102 may have four omni wheels, two of which provide lateral movement in the cross-process direction.

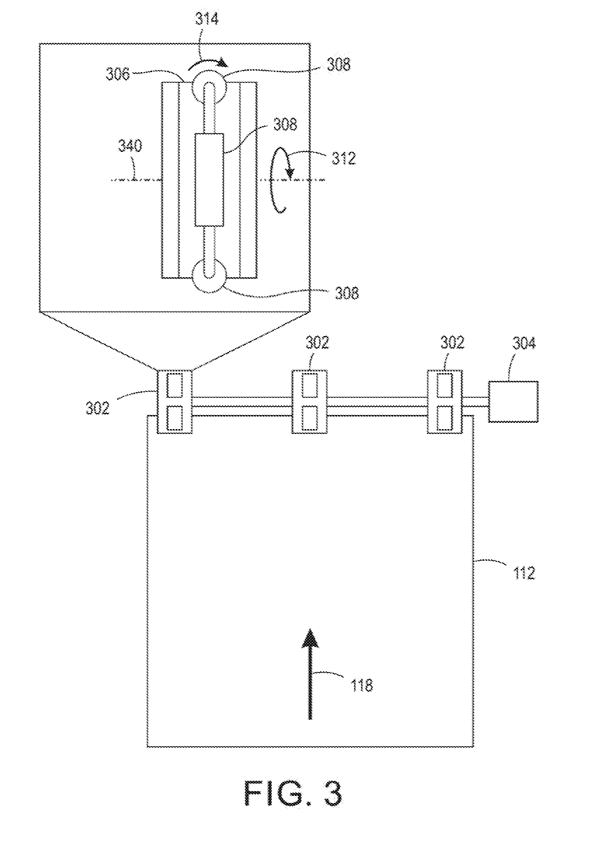

In one embodiment, the multi-rotational wheel 104 may be a Liddiard wheel 302 illustrated in FIG. 3. Each Liddiard wheel 302 may include a body portion 306 that rotates around an axis 340 as shown by an arrow 312. The body portion 306 may be a donut shape have an opening in a center of the body portion 306 (e.g., an area where the axis 340 runs through).

Each Liddiard wheel 302 may also include a plurality of roller components 308 located around an outer perimeter of the body portion 306. The plurality of roller components 308 may rotate around an axis that runs through the center of the roller components 308 and is perpendicular to the axis 340. As a result, the plurality of roller components 308 may rotate as shown by an arrow 314. The dimensions of the Liddiard wheel 302 and the plurality of roller components 308 and a number of the plurality of roller components 308 may be a function of a size of the print media 112 that the registration system 102 is designed to handle.

In one embodiment, the desired movement of the Liddiard wheels 302 may be a rotational speed of the body portion 306 and a rotational speed of the plurality of roller components 308. For example, the rotational speed of the body portion 306 and the plurality of roller components 308 may be via different motors.

In one embodiment, each one of the Liddiard wheels 302 may be coupled to a first motor 304 that controls rotation of the body portion 306 around the axis 340. Each one of the plurality of roller components 308 may also be coupled to a second motor (not shown) that is located in the Liddiard wheel 302. Thus, the plurality of roller components 308 may be controlled independently of the rotation of the body portion 306.

In one embodiment, the Liddiard wheel 302 may include an outer covering fabricated from a rubber or flexible plastic (not shown) that encloses the entire body portion 306 and the plurality of roller components 308. As the plurality of roller components 308 are rotated, the rotation may cause the outer covering to also revolve around the body portion 306. As a result, the Liddiard wheel 302 provides multiple directions of rotation.

In one embodiment, the Liddiard wheels 302 may be arranged and aligned in a cross-process direction (e.g., a direction that is perpendicular to the process direction 118). The Liddiard wheels 302 may be positioned such that the body portion 306 rotates in the process direction 118 and such that the plurality of roller components 308 rotates in the cross process direction. As a result, the rotation of the body portion 306 may provide forward drive of the print media 112. In addition, rotating different Liddiard wheels 302 at different rotational speeds may adjust a skew of the print media 112.

The rotation of the plurality of roller components 308 may adjust a lateral position of the print media 112. In one embodiment, both the skew and lateral position may be simultaneously adjusted by controlling the rotation of the body portion 306 and the plurality of roller components 308 of each Liddiard wheel 302. In other words, the Liddiard wheel 302 may move the print media 112 diagonally to adjust skew and lateral position of the print media 112 without overcorrection and/or “tail-wagging.”

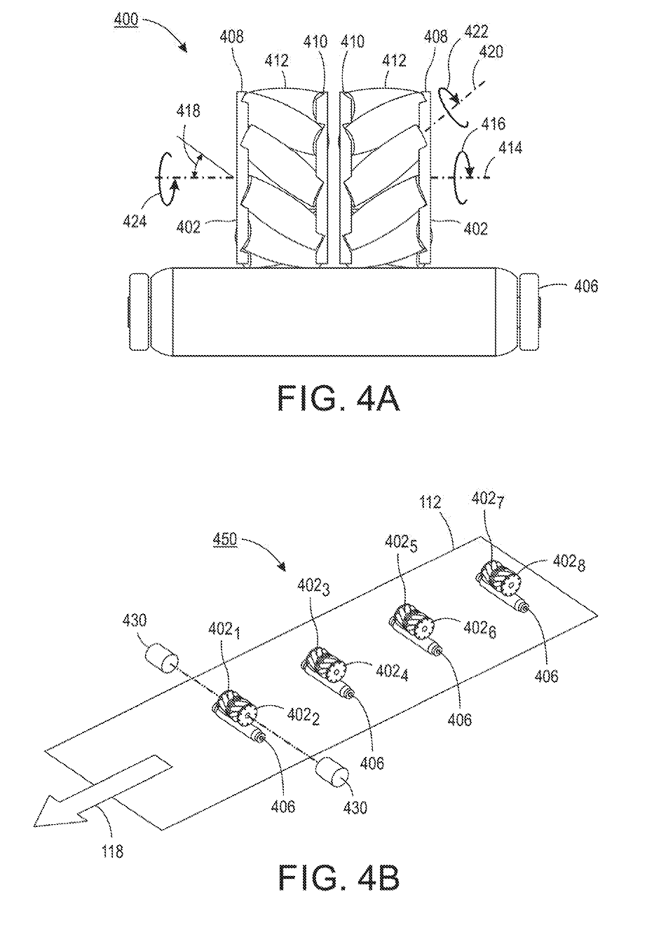

In one embodiment, the multi-rotational wheel 104 may be a mecanum wheel 402 illustrated in FIG. 4A. A view 400 illustrates two mecanum wheels 402. Each mecanum wheel may be adjacent to an idler roller 406. The print media 112 may travel between the mecanum wheels 402 and the idler roller 406.

Each mecanum wheel 402 may include a body portion that is comprised of a first wall 408 and a second wall 410. A plurality of roller components 412 may be coupled at an angle 418 to the first wall 408 and the second wall 410. The plurality of roller components 412 may be an approximately cylindrical shape with a smooth surface. The plurality of roller components 412 may be fabricated from a rubber or a plastic. The dimensions of the mecanum wheel 402 and the plurality of roller components 412 and a number of the plurality of roller components 412 may be a function of a size of the print media 112 that the registration system 102 is designed to handle.

In one embodiment, the angle 418 may be approximately 30 degrees. In contrast, traditional mecanum wheels are designed to have the plurality of roller components angled at 45 degrees. However, for a printing device, it has been found that the angle 418 of approximately 30 degrees may be optimal for handling print media within the registration system 102. In one embodiment, the angle 418 may be measured between an axis 414 that the body portion (e.g., the first wall 408 and the second wall 410) rotates around and a respective axis 420 that each roller component 412 rotates around.

The view 400 illustrates the mecanum wheels 402 arranged as a pair with the roller components 412 arranged in opposing directions. However, it should be noted that the mecanum wheels 402 may be arranged with the roller components 412 oriented in any direction. For example, a pair of mecanum wheels 402 may be arranged as shown in the view 400. The mecanum wheels 402 may be arranged with the roller components 412 in opposing directions such that the roller components 412 have an outer end that is located lower than the inner end. In another embodiment, the mecanum wheels 402 may be arranged such that the roller components 412 are angled in the same direction (e.g., both angled like the roller components 412 of the left mecanum wheel 402 in the view 400 or both angled like the roller components 412 of the right mecanum wheel 402 in the view 400).

In one embodiment, the body portion may rotate around the axis 414 in either direction as shown by an arrow 416 and an arrow 424. The plurality of roller components may each rotate around the respective axis 420 as shown by an arrow 422. In one embodiment, the desired movement may be a rotational speed of the mecanum wheel 402.

A view 450 illustrates an arrangement of mecanum wheels 402₁ to 402ₙ (also referred to herein individually as a mecanum wheel 402 or collectively as mecanum wheels 402). In one embodiment, each one of the mecanum wheels 402 may be coupled to a respective motor 430. The processor 108 may be coupled to the respective motors 430 and control the rotation speed of the mecanum wheels 402 based on the skew and the lateral position that is detected by the sensor 106. Although the motors 430 are shown only coupled to the mecanum wheels 402₁ and 402₂, it should be noted that a motor 430 may be coupled to each of the mecanum wheels 402₁ to 402ₙ.

In one embodiment, the mecanum wheels 402 may be arranged as pairs. Multiple pairs of mecanum wheels 402 may be arranged in the process direction 118 along a center of the registration system 102. Each pair of mecanum wheels 402 may be located adjacent to one another (e.g., a first mecanum wheel 402₁ that is adjacent to a second mecanum wheel 402₂). In another embodiment, the mecanum wheels 402 may be paired with a spacing between the mecanum wheels (e.g., the mecanum wheels 402₁ and 404₂ may be spaced apart by a width of the print media 112). In some embodiments, the mecanum wheels may be arranged individually or not in pairs.

In one embodiment, the pair of mecanum wheels 402 may be positioned such that the plurality of roller components 412 of the first mecanum wheel 402₁ and the second mecanum wheel 402₂ are angled in opposing directions. In other words, the plurality of roller components 412 of the first mecanum wheel 402₁ may be at +30 degrees and the plurality of components 412 of the second mecanum wheel 402₂ may be at −30 degrees. However, it should be noted that the roller components 412 may be arranged in different orientations. For example, the roller components 412 of the first mecanum wheel 402₁ may be at −30 degrees and the roller components 412 of the second mecanum wheel 402₂ may be at +30 degrees. In another example, the roller components 412 of both the first mecanum wheel 402₁ and 402₂ may be in the same orientation at −30 degrees, or both may be at +30 degrees.

In one embodiment, when the pair of mecanum wheels 402 is rotated in the same direction, the print media 112 may be driven forward. In one embodiment, when one of the pair of mecanum wheels 402 is rotated, or when the pair of mecanum wheels 402 is rotated at different rotational speeds and/or directions, the plurality of roller components 412 may adjust a skew and a lateral position of the print media 112 simultaneously.

In one embodiment, the pair of mecanum wheels 402 may be rotated in the same direction as discussed above. In another embodiment, the pair of mecanum wheels 402 may be rotated in opposing directions. The direction of rotation of the mecanum wheels 402 may be based on an orientation of the plurality of roller components 412 and a desired direction of the print media 112 based on the orientation of the plurality of roller components 412 of the mecanum wheels 402. An operational direction of a respective motor 430 may correspond with a desired rotational direction of the mecanum wheel 402.

In one embodiment, a series of pairs of mecanum wheels arranged as shown in FIG. 4B may allow the skew and the lateral positioned of the print media to be adjusted. For example, the processor 108 may control a respective motor 430 of each mecanum wheel 402 of the pairs of mecanum wheels.

As a result, the design of the multi-rotational wheels 104 allows the registration system 102 to handle any size or dimensioned print media 112. In addition, the multi-rotational wheels 104 allows the registration system 102 to be simplified. For example, a laterally moving carriage may be removed and various nips may be replaced or removed. As a result, the print jobs may operate more efficiently as the delay caused by opening and closing some nips may be eliminated.

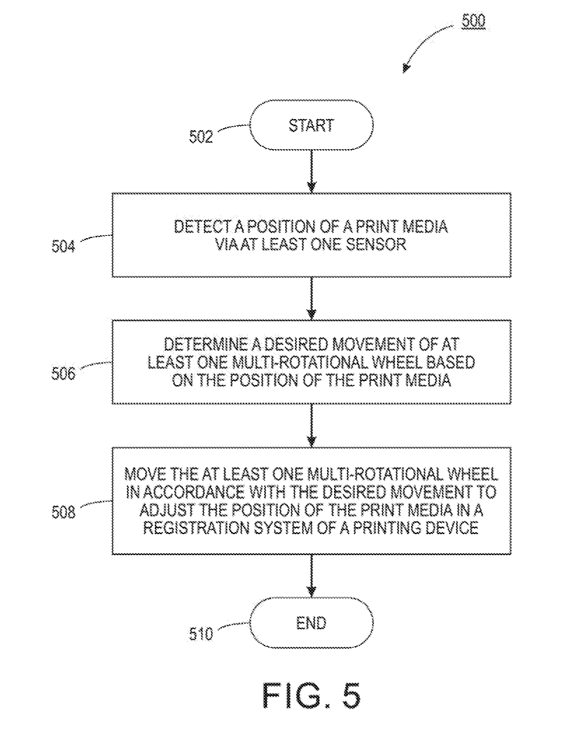

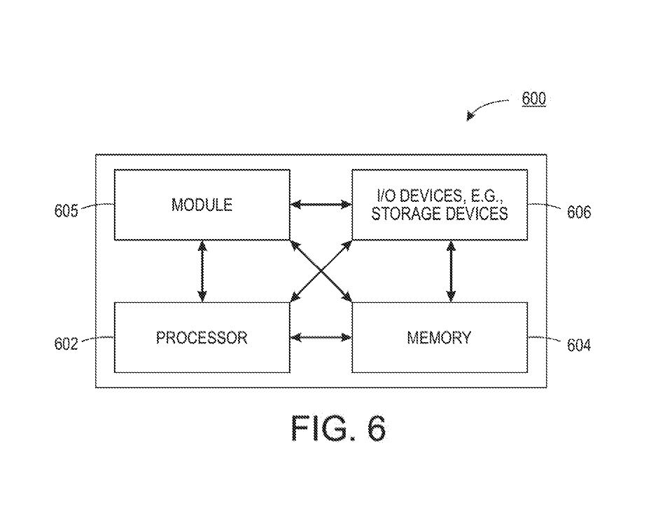

FIG. 5 illustrates a flowchart of an example method 500 for controlling a position of a print media in a registration system. In one embodiment, one or more steps or operations of the method 500 may be performed by the registration system 102, or a computer/processor that controls operation of the registration system 102 as illustrated in FIG. 6 and discussed below.

At block 502, the method 500 begins. At block 504, the method 500 detects a position of the print media via at least one sensor. In one embodiment, the print media may be any type of paper.

The skew may be an angle that the print media is tilted off of a straight line in the process direction. The lateral position may measure an amount that the print media is laterally away from a desired alignment position. For example, for a center registered system, the lateral position may include an amount and a direction (e.g., inboard or outboard) that the print media is off-center. For an edge registered system, the lateral position may include an amount of lateral movement away from the alignment edge.

At block 506, the method 500 determines a desired movement of at least one multi-rotational wheel based on the position of the print media. In one embodiment, the position of the print media may be used to determine the desired movement. For example, the print media may be laterally positioned 0.5 millimeters (mm) off of the registration edge and have a skew angle of 2 degrees towards the outboard side. The method 500 may determine the desired movement to adjust a position of the print media to move laterally towards the registration edge by 0.5 mm and adjust the skew angle back to 0 degrees.

In one embodiment, the desired movement of the multi-rotational wheel may include a rotational speed of the multi-rotational wheel (e.g., the body portion of each multi-rotational wheel and/or the plurality of roller components of each multi-rotational wheel). The multi-rotational wheels that are activated and the amount of rotational speed of the activated multi-rotational wheels may be based on the amount of movement to needed to adjust the skew and the lateral position by a desired amount. As discussed above, the multi-rotational wheels may include an omni wheel, a Liddiard wheel, or a mecanum wheel.

At block 508, the method 500 moves the at least one multi-rotational wheel in accordance with the desired movement to adjust the position of the print media in the registration system of a printing device. As discussed above, certain multi-rotational wheels may rotate to move the print media in a certain direction. For example, one multi-rotational wheel may move the print media in the process direction, one multi-rotational wheel may move the print media laterally in one direction, a combination of multi-rotational wheels at different rotational speeds may rotate the print media to adjust the skew of the print media, or simultaneously adjust the lateral position and the skew of the print media, and the like. At block 510, the method 500 ends.

It should be noted that the blocks in FIG. 5 that recite a determining operation or involve a decision do not necessarily require that both branches of the determining operation be practiced. In other words, one of the branches of the determining operation can be deemed as an optional step. In addition, one or more steps, blocks, functions or operations of the above described method 500 may comprise optional steps, or can be combined, separated, and/or performed in a different order from that described above, without departing from the example embodiments of the present disclosure.

FIG. 6 depicts a high-level block diagram of a computer that is dedicated to perform the functions described herein. As depicted in FIG. 6, the computer 600 comprises one or more hardware processor elements 602 (e.g., a central processing unit (CPU), a microprocessor, or a multi-core processor), a memory 604, e.g., random access memory (RAM) and/or read only memory (ROM), a module 605 for controlling a position of a print media in a registration system, and various input/output devices 606 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computer may employ a plurality of processor elements.

It should be noted that the present disclosure can be implemented in software and/or in a combination of software and hardware deployed on a hardware device, a computer or any other hardware equivalents (e.g., the registration system 102). For example, computer readable instructions pertaining to the method(s) discussed above can be used to configure a hardware processor to perform the steps, functions and/or operations of the above disclosed methods. In one embodiment, instructions and data for the present module or process 605 for controlling a position of a print media in a registration system (e.g., a software program comprising computer-executable instructions) can be loaded into memory 604 and executed by hardware processor element 602 to implement the steps, functions or operations as discussed above in connection with the example method 500. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 605 for controlling a position of a print media in a registration system (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A registration system for a printing device, comprising:
at least one sensor to detect a position of a print media fed from a feeder module;
a platform comprising at least one multi-rotational wheel, wherein the at least one sensor is located upstream of the at least one multi-rotational wheel; and
a processor communicatively coupled to the at least one sensor and the at least one multi-rotational wheel, wherein the processor calculates a desired movement of the at least one multi-rotational wheel based on the position of the print media to align the print media with an imaging module that prints a desired image onto the print media.

2. (canceled)

3. The registration system of claim 1, wherein the at least one multi-rotational wheel comprises:
a body portion that rotates around a first axis of rotation;
a plurality of roller components coupled to the body portion that rotate in a second axis of rotation that is different than the first axis of rotation; and
a motor coupled to the body portion.

4. The registration system of claim 3, wherein the at least one multi-rotational wheel comprises a plurality of omni wheels.

5. The registration system of claim 4, wherein the plurality of roller components are coupled along a perimeter of the body portion and the second axis of rotation is perpendicular to the first axis of rotation.

6. The registration system of claim 4, wherein the body portion of a first one of the plurality of omni wheels rotates in a process direction and the body portion of a second one of the plurality of omni wheels rotates in a cross-process direction.

7. The registration system of claim 6, wherein the desired movement comprises a rotational speed of the first one of the plurality of omni wheels and the second one of the plurality of omni wheels.

8. The registration system of claim 3, wherein the at least one multi-rotational wheel comprises a plurality of Liddiard wheels.

9. The registration system of claim 8, wherein the plurality of roller components are coupled along a perimeter of the body portion and the second axis of rotation is perpendicular to the first axis of rotation.

10. (canceled)

11. The registration system of claim 9, wherein desired movement comprises a rotational speed of the body portion of the Liddiard wheel and a rotational speed of the plurality of roller components.

12. The registration system of claim 8, wherein the plurality of Liddiard wheels are aligned in a cross-process direction.

13. The registration system of claim 3, wherein the at least one multi-rotational wheel comprises a plurality of mecanum wheels.

14. The registration system of claim 13, wherein the body portion comprises a first wall and a second wall, wherein the plurality of roller components are coupled between the first wall and the second wall along a perimeter of the body portion at an angle.

15. The registration system of claim 14, wherein the angle comprises approximately 30 degrees relative to the first axis of rotation of the body portion.

16. The registration system of claim 13, wherein the plurality of mecanum wheels comprises a first mecanum wheel and a second mecanum wheel, wherein the first mecanum wheel and the second mecanum wheel are aligned along a center of the registration system along the process direction.

17. The registration system of claim 16, wherein the first mecanum wheel and the second mecanum wheel rotate in opposite directions or in a same direction.

18. The registration system of claim 17, wherein the desired movement comprises a rotation speed of the first mecanum wheel and the second mecanum wheel.

19. A method for controlling a position of a print media in a registration system, comprising:
detecting a position of a print media fed from a feeder module via at least one sensor wherein the at least one sensor is located upstream of at least one multi-rotational wheel;
determining a desired movement of the at least one multi-rotational wheel based on the position of the print media; and
moving the at least one multi-rotational wheel in accordance with the desired movement to adjust the position of the print media in the registration system of a printing device.

20. A registration system for a printing device, comprising:
at least one sensor to detect a position of a print media fed from a feeder module;
a platform comprising a plurality of mecanum wheels, wherein the plurality of mecanum wheels comprises a body portion comprising a first wall and a second wall that rotate around a first axis of rotation, a plurality or roller components coupled between the first wall and the second wall along a perimeter of the body portion at an angle of approximately 30 degrees relative to a first axis of rotation of the body portion, wherein the plurality of roller components rotate in a second axis of rotation that is different than the first axis of rotation, and a motor coupled to the body portion, wherein the at least one sensor is located upstream of the plurality of mecanum wheels; and
a processor communicatively coupled to the at least one sensor and the plurality of mecanum wheels, wherein the processor calculates a desired movement of the plurality of mecanum wheels based on the position of the print media to align the print media with an imaging module that prints a desired image onto the print media.
